(19) United States
(12) Patent Application Publication
(10) Pub. No.: US 2009/0096744 A1
(43) Pub. Date: Apr. 16, 2009

(54) DISPLAY DEVICE AND GAMMA DATA ADJUSTING METHOD THEREOF

(76) Inventors: Joo-young KIM, Suwon-si (KR); Cheol-woo PARK, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/163,124

(22) Filed: Jun. 27, 2008

(30) Foreign Application Priority Data
Oct. 11, 2007 (KR) 10-2007-0102737

(51) Int. Cl. G09G 3/34

(52) U.S. Cl. 345/107; 345/690

(57) ABSTRACT

A display device including a display panel which displays an image, a signal controller which comprises a gamma data storing unit, and receives an external signal to drive the display panel. The signal controller extracts a gamma data signal from the external signal, stores the gamma data signal in the gamma data storing unit, and controls displaying of an image based on the gamma data signal to the display panel.

### CROSS-REFERENCE TO RELATED APPLICATION

This application claims priority from Korean Patent Application No. 10-2007-0102737, filed on Oct. 11, 2007 in the Korean Intellectual Property Office, the disclosure of which is incorporated herein by reference in its entirety.

### BACKGROUND OF THE INVENTION

1. Field of the Invention

The present invention relates to a display device and a gamma data adjusting method for use with the display device.

2. Description of the Related Art

There are various types of display devices. Recently, a display device employing an E-paper display device capable of providing a clear image for a long time using a small driving power has been developed.

The E-paper device uses an electrophoretic display panel for displaying an image resulting from movement of micro particles by means of an electric field.

The electrophoretic display panel includes a pair of electrodes which generate an electric field. Electrophoretic particles are disposed between the pair of electrodes. The electrophoretic display panel displays a color by means of an electrostatic movement of the particles within a specific space. Since there is no positional change of the particles after removal of the electric field when the movement of the particles has been completed in any pole, the image does not disappear, thus giving an effect of an image printed with ink on paper. More particularly, although an electrophoretic display panel does not emit light, viewing the electrophoretic display panel results in low visual fatigue, thus providing comfortable viewing as if reading a printed page. Also, the electrophoretic display panel is flexible, and is relatively thin and light. Also, since a displayed image is maintained for a long time, power consumption is considerably low, making it an excellent choice for use as a portable display device. Accordingly, the electrophoretic display panel is expected to function as a future flat panel display.

A gray e (gradation expression) of a display device including an electrophoretic display panel is performed by changing an application time or the magnitude of a voltage applied in driving. That is, unlike a liquid crystal display which expresses the gray by adjusting the magnitude of data voltage using a resistance string, etc., a display device including an electrophoretic display panel expresses the gray by adjusting the amount of time that a voltage is applied, as well as the magnitude of the data voltage.

However, conventional display devices are incapable of changing a gamma data signal which is initially determined and are for changing the gray. That is, the conventional E-paper device displays an image with an initially determined gray scale expression.

### SUMMARY OF THE INVENTION

Additional aspects of the present invention will be set forth in part in the description which follows and, in part, will be obvious from the description, or may be learned by practice of the present invention.

The foregoing and/or other aspects of the present invention can be achieved by providing a display device, including: a display panel, and a signal controller including an input for receiving an external signal to drive the display panel, the signal controller unit including a gamma data storing unit, and being operative to extract a gamma data signal from the external signal, store the gamma data signal in the gamma data storing unit, and control a gray expression of an image based on the gamma data signal to the display panel.

The external signal may include a command flag signal, a clock signal and data signals, and the command flag signal comprises a starting command flag signal, and an ending command flag signal.

When the data signal which may be transmitted together with the starting command flag signal is determined to be a gamma data transmission command, the signal controller may recognize the data signal which is received in synchronization with the clock signal after the starting command flag signal as the gamma data signal.

The signal controller may store the recognized gamma data signal in the gamma data storing unit.

The gamma data storing unit may be a flash memory type.

When the data signal which may be transmitted together with the starting command flag signal is not determined to be a gamma data transmission command, the signal controller may execute a command which the data signal represents.

The command which the data signal represents may include one of an image display command and an image data transmission command.

The command flag signal and the clock signal may be respectively an one bit signal, and the data signal may be an eight bit signal.

The gamma data signal may include a plurality of unit signals, and each unit signal defines a data application time for each gray.

The display panel may include 16 grays, and the gamma data signal may include 15 unit signals.

The display panel may include an electrophoretic display panel.

The foregoing and/or other aspects of the present invention can be achieved by providing a gamma data adjusting method of a display device, including: transmitting a starting command flag signal to a signal controller which includes a gamma data storing unit, recognizing a first data signal which is transmitted together with the starting command flag signal as a command signal, determining whether the first data signal is a gamma data transmission command or not, recognizing a second data signal which is transmitted to the signal controller in synchronization with a clock signal after the starting command flag signal as a new gamma data signal if the first data signal is determined to be the gamma data transmission command, storing the new gamma data signal in the gamma data storing unit, and ending the recognizing and storing of the new gamma data signal when the signal controller receives an ending command flag signal.

The method may further include displaying an image on a display panel, wherein the display panel expresses a gray of the image depending on the new gamma data signal.

The signal control unit may drive the display panel depending on a second data signal which is not recognized as the gamma data signal after receiving the ending command flag signal.

The gamma data storing unit may be a flash memory type.

The gamma data signal may include a plurality of unit signals, and each unit signal may define a data application time for each gray.

The display panel may include 16 grays, and the gamma data signal may include 15 unit signals.

The display panel may include an electrophoretic display panel.

### BRIEF DESCRIPTION OF THE DRAWINGS

These foregoing and other aspects of the present invention will become apparent and more readily appreciated from the following description of the exemplary embodiments, taken in conjunction with the accompanying drawings, in which:

FIG. 1 is a block diagram of a display device according to an exemplary embodiment of the present invention;

FIG. 2 shows a waveform diagram of a command flag signal, a clock signal, and data signals according to an exemplary embodiment of the present invention;

FIG. 3 is a flowchart illustrating an operation of a signal controller according to an exemplary embodiment of the present invention;

FIG. 4A illustrates an example of a gamma data signal according to the prior art;

FIG. 4B illustrates gray steps obtained in applying a black data voltage based on the gamma data signal shown in FIG. 4A;

FIG. 5 illustrates data signals that are function as a gamma data signal between a starting command flag signal and an ending command flag signal according to an exemplary embodiment of the present invention;

FIG. 6A illustrates an example of a gamma data signal according to an exemplary embodiment of the present invention; and

FIG. 6B illustrates gray steps obtained in applying a black data voltage based on the gamma data signal shown in FIG. 6A.

### DETAILED DESCRIPTION OF EXEMPLARY EMBODIMENTS OF THE INVENTION

Reference is made below in detail to the embodiments of the present invention, examples of which are illustrated in the accompanying drawings, wherein like reference numerals refer to like elements throughout. The exemplary embodiments are described below so as to explain the present invention by referring to the figures.

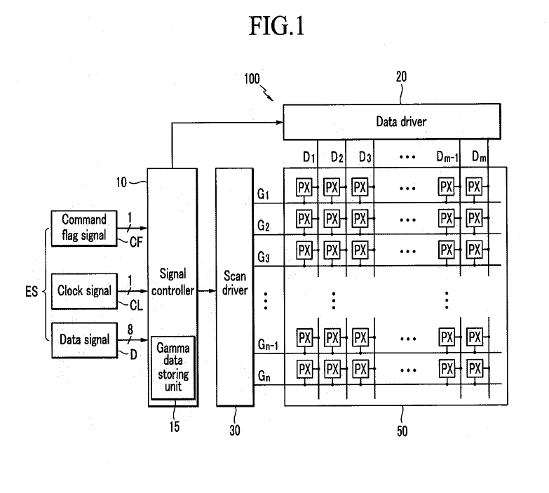

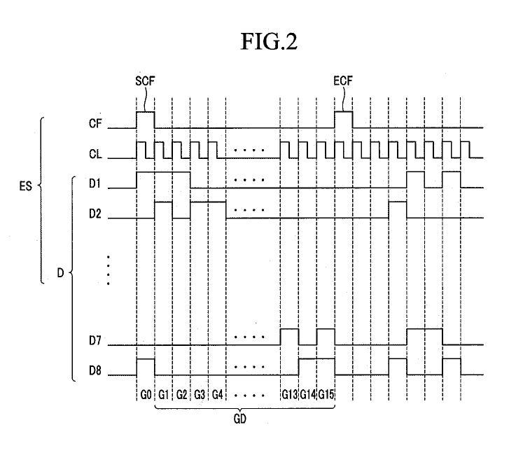

A display device according to an exemplary embodiment of the present invention will be described with reference to FIGS. 1 and 2.

FIG. 1 is a block diagram schematically illustrating a configuration of a display device according to an exemplary embodiment of the present invention. FIG. 2 shows a waveform diagram of a command flag signal, a clock signal, and data signals according to an exemplary embodiment of the present invention.

As shown in FIGS. 1 and 2, the display device 100 includes a signal controller 10, a data driver 20, a scan driver 30, and a display panel 50.

Referring to FIG. 1, the display panel 50 includes a plurality of signal lines G₁-Gₙ and D₁-Dₘ, and a plurality of pixels PX arranged substantially in a matrix form.

The display panel 50 may includes lower and upper display panels (not shown), and an electrophoretic layer (not shown) interposed between the lower and upper display panels. The lower display panels include a plurality of first electrodes and the upper display panel includes a second electrode.

The signal lines include a plurality of gate lines G₁-Gₙ that transfer gate signals and a plurality of data lines D₁-Dₘ that transfer data voltages.

Each pixel PX may includes a switching element (not shown), an electrophoretic capacitor (not shown), and a storage capacitor (not shown).

The switching element may be three-terminal element such as a thin film transistor, etc., provided at the lower display panel. A control terminal of the switching element is connected to one gate line G₁-Gₙ, an input terminal of the switching element is connected to one data line D₁-Dₘ, and an output terminal of the switching element is connected to the electrophoretic capacitor and the storage capacitor.

The electrophoretic capacitor uses the first electrode of the lower display panel and the second electrode of the upper display panel as two terminals, and the electrophoretic layer between the first and second electrodes serves as a dielectric material.

The first electrode is connected with the switching element, and the second electrode is formed on the entire surface of the upper display panel and receives a predetermined voltage.

The electrophoretic layer may include, for example, white charged particles and black charged particles, and a transparent dielectric fluid.

The white particles and the black particles are charged with mutually opposite electric charges, for example, negative (−) charge and positive (+) charge.

The charged particles and the transparent dielectric fluid may be encapsulated in a micro-capsule. The signal controller 10 receives an external signal ES from an external device (not shown) to drive the display panel 50. The signal controller 10 receives the external signal ES, analyzes the external signal ES, extracts image signals by color, a gamma data signal, and a reference clock signal for respectively controlling an operation timing of the data driver 20 and the scan driver 30, etc. The external signal ES includes a command flag signal CF, a clock signal CL, and data signals D.

Referring to FIG. 2, the command flag signal CF includes a starting command flag SCF and an ending command flag ECF. The data signals D perform various functions depending on the existence and type of the command flag signal CF.

In this embodiment, the command flag signal CF and the clock signal CL is one bit signal, respectively, and each of the data signals D is eight bits (D1-D8). Thereby, the external signal ES which includes a total of ten bits is supplied to the signal controller 10. However, the total bit number of the external signal ES is not limited thereto. Alternatively, the data signal D may have more than eight bits. In addition, the external signal ES may further include at least one signal of other types.

The signal controller 10 receives the external signal ES through a plurality of signal input pins. The plurality of signal input pins include data signal input pins for the data signals, a clock signal input pin for the clock signal, and a command flag signal input pin for the command signal.

Also, the signal controller 10 includes a gamma data storing unit 15. The signal controller 10 recognizes portions of the data signals D as a gamma data signal GD shown in FIG. 2. The gamma data signal GD extracted from the data signals D is stored in the gamma data storing unit 15 of the signal controller 10.

Since the gamma data signal defines the application time of the image signal for each gray, the signal controller 10 outputs the image signals to the data driver 20 for a defined time based on the gamma data signal GD. The gamma data storing unit 15 may be, for example, a flash memory device, which maintains the stored gamma data signal GD in the absence of power, and which can store a new gamma data signal GD.

The scan driver 30 generates scan signals as a function of the reference clock from the signal controller 10 to output to scan lines G₁-Gₙ of the display panel 50.

The data driver 20 outputs data voltages generated based on the image signals to the pixels PX. As described above, the application time (refer to as “the data application time”) of the data voltages is defined by the gamma data signal GD.

As described above, the display panel 50 displays images by using the electrophoretic display process. That is, the display panel 50 includes the first electrodes and the second electrode which are used to generate an electric field, and electrophoretic particles such as the white charged particles and the black charged particles which are disposed between the first and second electrodes.

In the display panel 50, a color of an image displayed on the display panel 50 is defined by means of electrostatic movement of the electrophoretic particles which are moved in a defined space. For example, in the case that the white charged particles representing the white color move toward the second electrode, a white image is displayed, while in the case that the black charged particles representing the black color move toward the second, a black image is displayed.

Since there is no positional change of the particles after the electric field is removed the image remains. Accordingly, to display a next image, a reset operation is necessary.

The gray of the image displayed on the display panel 50 is defined by the data application time based on by the gamma data signal GD.

An operation of the signal controller 10 for recognizing the gamma data signal GD among the external signal ES is described in detail with reference FIG. 2.

As described above, in this embodiment, the external signal ES includes the command flag signal CF of one bit, the clock signal CL of one bit, and the data signals D, each which is eight bits. When the signal controller 10 recognizes a starting command flag signal SCF, a data signal G0 concurrently transmitted together with the corresponding starting command flag signal SCF is recognized as a command. At this time, when the recognized command is a command (hereinafter, referred to as “a gamma data transmission command”) for transmitting the gamma data signal GD, the signal controller recognizes the data signals D (G1-G15) transmitted in synchronization with the clock signal CL after the starting command flag signal SCF and till the ending command flag signal ECF is recognized, as the gamma data signal GD. The recognized gamma data signal GD is also newly stored in the gamma data storing unit 15.

Here, if the image displayed in the display panel 50 has 16 grays, the gamma data signal GD includes 15 unit signals G1 to G15. Each unit signal G1 to G15 corresponds to one data signal D of eight bits.

Each unit signal G1 to G15 defines a data application time for each gray expressed by the image. That is, each unit signal G1 to G15 defines a data application time of a data voltage applied to express each gray.

Alternatively, the number of gray of the image displayed in the display panel 50 may be less than 16 grays such as four grays, or may be more than 16 grays such as 32 grays.

Thereby, the display device 100 adjusts the gamma data signal GD to change the gray expression as necessary.

For example, in tuning process, a manufacturer producing a product using the display device 100 inputs an external signal ES including a gamma data signal GD to output the display device 100, to adjust the gray expression of the display device 100, and thereby obtaining a desired gray state. Also, an user can execute software to perform a tuning operation. By the execution of the software, an external signal ES including a gamma data signal GD are input to the display panel 50 through a computer, etc., and then adjust the gray expression of the display device 100 to a desired gray state.

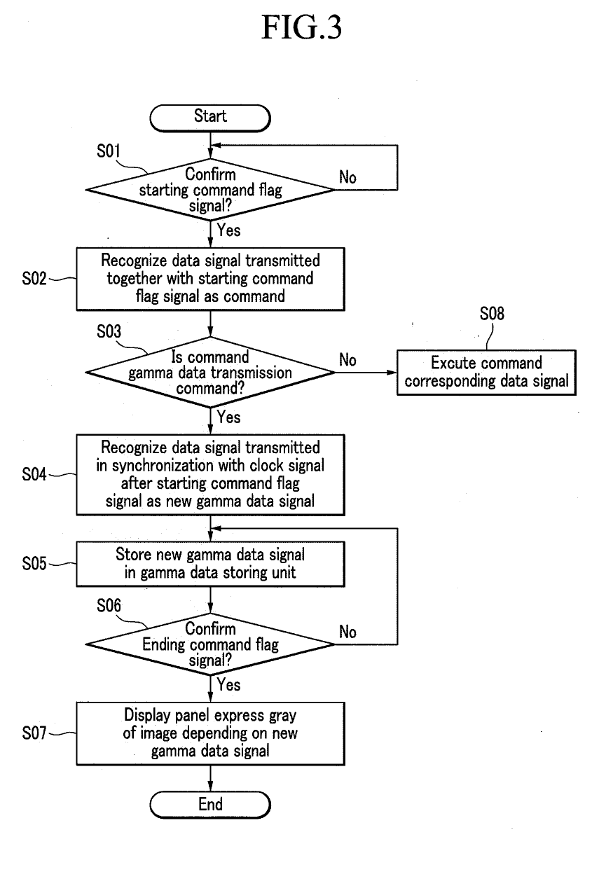

Hereinafter, an operation of the signal controller 10 for adjusting a gamma data signal of the display device 100 according to an exemplary embodiment of the present invention is described with reference to FIG. 3.

FIG. 3 is a flowchart illustrating an operation of a signal controller according to an exemplary embodiment of the present invention.

As shown in FIG. 3, the signal controller 10 determines whether a starting command flag signal SCF is input. As described, the starting command flag signal SCF is a signal for recognizing a gamma data signal GD in an external signal ES or not (S01). When the starting command flag signal SCF of a high level is not input, the signal controller 10 returns to the step “S01”. Thereby, the signal controller 10 maintains an existing gray expression using the gamma data signal GD stored in the gamma data storing unit 15.

When the starting command flag signal SCF of the high level is input, the signal controller 10 recognizes a data signal G0 transmitted together with the starting command flag signal SCF as a command (S02), and determines whether the data signal G0 is a gamma data transmission command or not (S03).

When the data signal G0 is determined as the gamma data transmission command, data signals G1 to G15 transmitted in synchronization with a clock signal CL after the data signal G0 is recognized as a new gamma data signal GD (S04).

If the data signals G1 to G15 transmitted in synchronization with the clock signal CL after the starting command flag signal SCF are recognized as the new gamma data signal GD (S04), the signal controller 10 stores the new gamma data signal GD in the gamma data storing unit 15 (S05). Thereby, the gamma data signal GD stored in the gamma data storing unit 15 is changed to the new gamma data signal.

This process continues until an ending command flag signal ESF is input to the signal controller 10 (S06).

When the ending command flag signal ESF of the high level is input to the signal controller 10, the signal controller 10 completes an the operation for changing the gamma data signal of the gamma data storing unit 15 to the new gamma data signals. Then, the signal controller 10 controls the gray expression of an image displayed on the display panel 50, based on the changed gamma data signal GD (S07).

When the data signal GO transmitted together with the starting command flag signal SCF is not the gamma data transmission command, the signal controller 10 controls an operation of the display device 100 in accordance with a command corresponding to the data signal Go (S08).

For example, when the transmitted data signal G0 is determined to be an image signal transmission command, the signal controller 10 recognizes data signals G1-G15 transmitted in synchronization with the clock signal CL after the starting command flag signal SCF as new image signals. Accordingly, the signal controller 10 stores the new image signals in an image signal storing unit (not shown) provided inside or outside of the signal controller 10.

Alternatively, when the transmitted data signal G0 is determined to be an image display command, the signal controller 10 outputs the image signals stored in the image signal storing unit to the data driver 20. The data driver 20 modifies the image signals to corresponding data voltages to output them to the data lines D₁-Dₘ.

In the embodiment, when the starting command flag signal SCF and the ending command flag signal ESF have a high level, the controller 10 determines the input of the starting and ending command flag signals SCF and ECF. However, the controller 10 may operate in synchronization with a low level of the starting and ending command flag signals SCF and ECF.

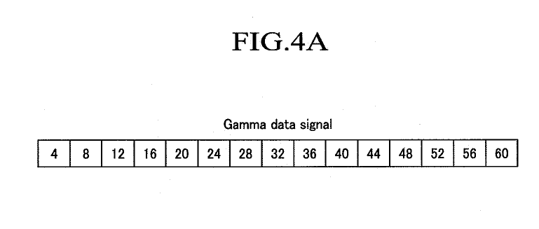

The gamma data signal GD according to the exemplary embodiment of the present invention will be described in detail with reference to FIGS. 4A to 6B, as compared with gamma data signal according to the prior art.

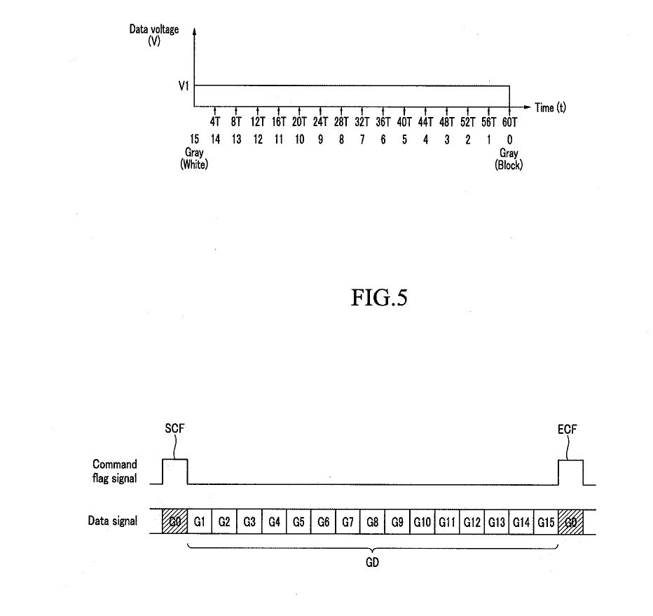

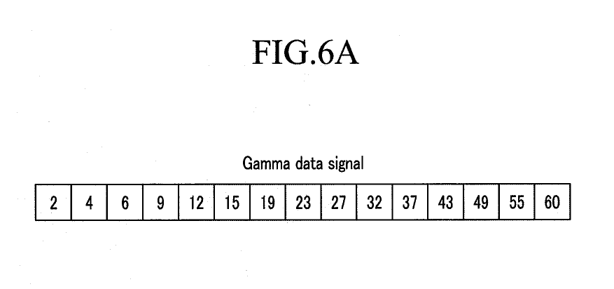

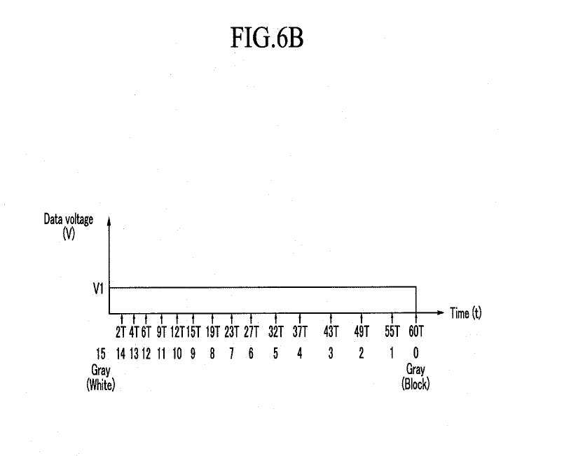

FIG. 4A illustrates an example of a gamma data signal according to the prior art, and FIG. 4B illustrates gray steps obtained in applying a black data voltage based on the gamma data signal shown in FIG. 4A. In addition, FIG. 5 illustrates data signals that are function as a gamma data signal between a starting command flag signal and an ending command flag signal according to an exemplary embodiment of the present invention, FIG. 6A illustrates an example of a gamma data signal according to an exemplary embodiment of the present invention, and FIG. 6B illustrates gray steps obtained in applying a black data voltage based on the gamma data signal shown in FIG. 6A.

Here, it is assumed that the time of 60T is necessary to display from the highest gray to the lowest gray of the total 16 grays (0 gray to 15 gray) or vice versa in the display panel 50. In this embodiment, the highest gray (gray 15) displays white and the lowest gray (gray 0) displays black. However, alternatively, the highest gray (gray 15) may display black and the lowest gray (gray 0) displays white.

Referring to FIG. 4A, a gamma data signal according to the prior art include 15 unit signals, and thereby is for 16 grays.

In FIG. 4A, a value (4, 8, 12, . . . ,52, 56, 60) of each unit signal represents the data application time for obtaining each gray.

Since the display panel 50 displays an image by using an electrophoretic display process, the gray is varied by the data application time

As shown in FIG. 4B, white is displayed if a data voltage V1 (referred to as “a black data voltage”) for displaying black is not applied, and an image displays a color closer to black as the data application time of the black data voltage V1 is elongated. Referring to FIG. 4B, when the black data voltage V1 is applied for about 4T, an image represents the 14-th gray, and when the black data voltage V1 is applied for about 44T, an image represents the 4-th gray.

As shown in FIGS. 4A and 4B, since all intervals between the data application times for two adjacent grays are uniform, the gray of the sixteen steps is divided to have the same interval.

FIG. 5 illustrates data signals D between starting command flag signal SCF and an end flag signal ECF of command flag signal, which are recognized as a gamma data signal GD by the signal controller 10 according to an exemplary embodiment of the present invention. In FIG. 5, the number of unit signals G1-G15 is 15.

In FIG. 6A, aa gamma data signal has includes 15 unit signals for 16 grays and a value (2, 4, 6, 9, . . . , 49, 55, 60) of each unit signal represents the data application time for obtaining each gray, like the above shown in FIG. 4A.

Referring to FIG. 6B, an image displayed in the display panel 50 has a new gray expression of sixteen steps from white to black which is different from the gray expression based on FIG. 4B.

Unlike FIGS. 4A and 4B, referring to FIGS. 6A and 6B, the data application times between two adjacent grays is not uniform. Thereby, since the data application time for the same gray is different from that of FIG. 4B, a gray expression of an image representing the same gray is also different that of an image represented based on FIG. 4B.

For example, in FIG. 6B, when the black data voltage V1 is applied for about 2T, an image represents the 14-th gray, but in FIG. 4B, when the black data voltage V1 is applied for about 4T, an image represents the 14-th gray. That is, the data application times for the same grays differs.

Referring FIG. 6B, since the data application times between two adjacent grays are shorter than those in FIG. 4B, the gray expression adjacent to the white becomes brighter than the gray expression adjacent to the white in FIG. 4B, since the data application times between two adjacent grays are longer than those in FIG. 4B, and the gray expression adjacent to the black becomes darker than the gray expression adjacent to the black in FIG. 4B. The present invention is not limited to the gamma data signal shown in FIGS. 4A, 5 and 6A, and the gamma data signal may be changed according to a design of a display device.

According to the present invention, since the gamma data signal that defines the data application time for each gray is varied using the external signal including the gamma data signal and the command flag signal, the gray expression for the same gray is changed as wanted.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display device, comprising:
a display panel; and
a signal controller comprising an input for receiving an external signal, the signal controller comprising a gamma data storing unit, the signal controller being operative to extract a gamma data signal from the external signal, store the gamma data signal in the gamma data storing unit, and control a gray expression of an image based on the gamma data signal to the display panel.

2. The display device of claim 1, wherein the external signal comprises a command flag signal, a clock signal, and data signals, and
the command flag signal comprises a starting command flag signal and an ending command flag signal.

3. The display device of claim 2, wherein, when the data signal which is transmitted together with the starting command flag signal is determined to be a gamma data transmission command, the signal controller recognizes a data signal which is received in synchronization with the clock signal after the starting command flag signal as the gamma data signal.

4. The display device of claim 3, wherein the signal controller stores the recognized gamma data signal in the gamma data storing unit.

5. The display device of claim 4, wherein the gamma data storing unit is a flash memory type.

6. The display device of claim 2, wherein, when the data signal which is transmitted together with the starting command flag signal is not determined to be a gamma data transmission command, the signal controller executes a command which the data signal represents.

7. The display device of claim 6, wherein the command which the data signal represents comprises one of an image display command and an image data transmission command.

8. The display device of claim 2, wherein the command flag signal and the clock signal are respectively an one bit signal, and the data signal is an eight bit signal.

9. The display device of claim 8, wherein the gamma data signal comprises a plurality of unit signals, and each unit signal defines a data application time for each gray.

10. The display device of claim 9, wherein the display panel comprises 16 grays, and the gamma data signal comprises 15 unit signals.

11. The display device of claim 1, wherein the display panel comprises an electrophoretic display panel.

12. A gamma data adjusting method of a display device, comprising:
transmitting a starting command flag signal to a signal controller which comprises a gamma data storing unit;
recognizing a first data signal which is transmitted together with the starting command flag signal as a command signal;
determining whether the first data signal is a gamma data transmission command or not;
recognizing a second data signal which is transmitted to the signal controller in synchronization with a clock signal after the starting command flag signal as a new gamma data signal when the first data signal is determined to be the gamma data transmission command;
storing the new gamma data signal in the gamma data storing unit; and
ending the recognizing and storing of the new gamma data signal when the signal controller receives an ending command flag signal.

13. The method of claim 12, further comprising displaying an image on a display panel,
wherein the display panel expresses a gray of the image depending on the new gamma data signal.

14. The method of claim 12, wherein the signal controller drives the display panel depending on a second data signal which is not recognized as the gamma data signal after receiving the ending command flag signal.

15. The method of claim 12, wherein the gamma data storing unit is a flash memory type.

16. The method of claim 12, wherein the gamma data signal comprises a plurality of unit signals, and each unit signal defines a data application time for each gray.

17. The method of claim 13, wherein the display panel comprises 16 grays, and the gamma data signal comprises 15 unit signals.

18. The method of claim 13, wherein the display panel comprises an electrophoretic display panel.
